(19) United States
(12) Patent Application Publication
(10) Pub. No.: US 2010/0160471 A1
(43) Pub. Date: Jun. 24, 2010

(54) Catalyst System for Moisture Cure of Ethylene-Vinylsilane Copolymers

(76) Inventors: Saurav S. Sengupta, Somerset, NJ (US); Abhijit Ghosh-Dastidar, East Brunswick, NJ (US); Bharat I. Chaudhary, Princeton, NJ (US)

Correspondence Address: Gary Plotecher;Whyte Hirschboeck Dudek S.C., Suite 1900, 555 E Wells Street, Milwaukee, WI, 53202, US

(21) Appl. No.: 12/630,915

(22) Filed: Dec. 4, 2009

Related U.S. Application Data
(60) Provisional application No. 61/140,207, filed on Dec. 23, 2008.

(51) Int. Cl. C08F 8/00; C08L 43/04; C08F 30/08

(52) U.S. Cl. 521/142; 525/326.5; 524/547

(57) ABSTRACT

Ethylene-vinylsilane copolymers are moisture-cured under ambient conditions using a synergistic combination of at least one Lewis acid and at least one Brønsted acid or at least one Lewis base and at least one Brønsted base. Preferably the catalyst system comprises a Lewis acid, e.g., dibutyltin dilaurate, in combination with a Brønsted acid, e.g., sulfonic acid. The Lewis acid or base and the Brønsted acid or base is present in the catalyst system at a molar ratio of Lewis acid/base to Brønsted acid/base of 1:10 to 10:1.

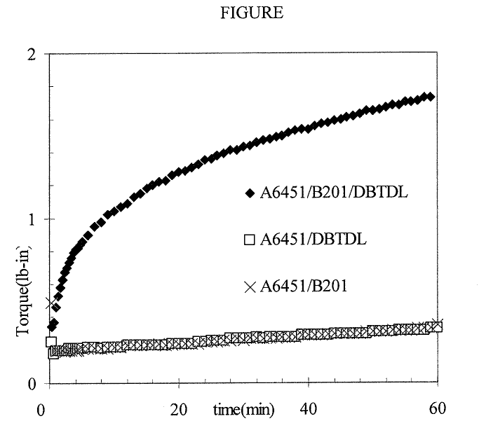

### CROSS-REFERENCE TO RELATED APPLICATIONS

The present application claims priority to U.S. patent application Ser. No. 61/140,207, filed on Dec. 23, 2008, the entire content of which is incorporated by reference herein.

### STATEMENT REGARDING FEDERALLY SPONSORED RESEARCH OR DEVELOPMENT

None

### FIELD OF THE INVENTION

This invention relates to ethylene-vinylsilane copolymers. In one aspect, the invention relates to the moisture cure of ethylene-vinylsilane copolymers while in another aspect, the invention relates to such a cure using a synergistic combination of Lewis and Brønsted acids or bases.

### BACKGROUND OF THE INVENTION

In the fabrication of articles such as cables, pipes, footwear, foams and the like, the polymeric compositions from which these articles are made are often be melt blended. The compositions often comprise silane-functionalized resins and a catalyst, and these resins undergo crosslinking through their silane functionalities upon exposure to moisture at either ambient or elevated temperature. Moisture-cured resins represent a significant portion of the market for crosslinked polyolefins in cable insulation today. They are generally restricted to articles of thin construction because the crosslinking chemistry requires the polymer to absorb moisture from the environment while below the melting point, and diffusion of water through semicrystalline, hydrophobic polymer is very slow.

Various catalysts are known to initiate and facilitate the moisture-cure of ethylene-vinylsilane copolymers. Among these known catalysts are the Brønsted acids, e.g., sulfonic acid. These acids, however, are relatively expensive and necessitate the use of relatively expensive antioxidants for ambient cure formulations. Less expensive catalyst technology is centered on Lewis acids, e.g., dibutyltin dilaurate (DBTDL), which enable post-fabrication cure at higher temperatures in water baths.

Of continuing interest to the cable industry, as well as the other industries that employ ethylene-vinylsilane copolymers, is a curing catalyst that is not only effective under ambient conditions, but also requires a relatively inexpensive antioxidant package.

### SUMMARY OF THE INVENTION

In one embodiment of this invention, ethylene-vinylsilane copolymers are moisture-cured using a synergistic combination of at least one Lewis acid and at least one Brønsted acid. In one embodiment of this invention ethylene-vinylsilane copolymers are moisture-cured under ambient conditions using a synergistic combination of at least one Lewis base and at least one Brønsted base. Preferably the catalyst system comprises a Lewis acid in combination with a Brønsted acid. The Lewis acid and the Brønsted acid or the Lewis base and the Brønsted base are present in the catalyst system at a molar ratio of Lewis acid/base to Brønsted acid/base of 1:10 to 10:1, preferably of 1:2 to 2:1 and more preferably of 1:2 to 1:1.5. Preferably the combination comprises more Brønsted acid than Lewis acid.

In one embodiment the invention is a process for crosslinking an ethylene-vinyl silane polymer, the process comprising the step of contacting the ethylene-vinylsilane polymer and water with a catalyst cure system comprising at least one Lewis acid and at least one Brønsted acid or of at least one Lewis base and at least one Brønsted base such that the rate of cure of the ethylene-vinylsilane polymer is greater than (>) 10, preferably >20, more preferably >30, even more preferably >40 and still more preferably >50, percent faster than the rate of cure of the same ethylene-vinylsilane polymer under the same conditions but with either of the Lewis acid or base or Brønsted acid or base alone as measured by moving die rheometer test as later described.

### BRIEF DESCRIPTION OF THE DRAWINGS

The FIGURE reports a cure rate comparison of a Lewis acid alone, a Brønsted acid alone, and a combination of the Lewis acid and the Brønsted acid.

### DETAILED DESCRIPTION OF THE PREFERRED EMBODIMENT

All references to the Periodic Table of the Elements refer to the Periodic Table of the Elements published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of Lewis acid or base and Brønsted acid or base in the catalyst cure system, and various temperatures and other process ranges.

“Cable” and like terms mean at least one wire or optical fiber within a protective insulation, jacket or sheath. Typically, a cable is two or more wires or optical fibers bound together, typically in a common protective insulation, jacket or sheath. The individual wires or fibers inside the jacket may be bare, covered or insulated. Combination cables may contain both electrical wires and optical fibers. The cable, etc. can be designed for low, medium and high voltage applications. Typical cable designs are illustrated in U.S. Pat. Nos. 5,246,783, 6,496,629 and 6,714,707.

“Polymer” means a compound prepared by reacting (i.e., polymerizing) monomers, whether of the same or a different type. The generic term polymer thus embraces the term “homopolymer”, usually employed to refer to polymers prepared from only one type of monomer, and the term “interpolymer” as defined below.

“Interpolymer” and “copolymer” mean a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

“Ethylene polymer”, “polyethylene” and like terms mean a polymer containing units derived from ethylene. Ethylene polymers typically comprises at least 50 mole percent (mol %) units derived from ethylene.

“Ethylene-vinylsilane polymer” and like terms mean an ethylene polymer comprising silane functionality. The silane functionality can be the result of either polymerizing ethylene with, e.g., a vinyl trialkoxy silane comonomer, or, grafting such a comonomer onto an ethylene polymer backbone as described, for example, in U.S. Pat. No. 3,646,155 or 6,048,935.

“Blend,” “polymer blend” and like terms mean a blend of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“Composition” and like terms mean a mixture or blend of two or more components. For example, in the context of preparing a silane-grafted ethylene polymer, a composition would include at least one ethylene polymer, at least one vinyl silane, and at least one free radical initiator. In the context of preparing a cable sheath or other article of manufacture, a composition would include an ethylene-vinylsilane copolymer, a catalyst cure system and any desired additives such as lubricant, fillers, anti-oxidants and the like.

“Catalyst cure system” and like terms means a combination comprising at least one Lewis acid and at least one Brønsted acid or at least one Lewis base and at least one Brønsted base that will promote the moisture cure of an ethylene-vinylsilane copolymer at an ambient and/or elevated temperature, e.g., 90° C. in a water bath.

“Catalytic amount” means an amount of catalyst cure system necessary to promote the crosslinking of an ethylene-vinylsilane polymer at a detectable level, preferably at a commercially acceptable level.

“Crosslinked”, “cured” and similar terms mean that the polymer, before or after it is shaped into an article, was subjected or exposed to a treatment which induced crosslinking and has xylene or decalene extractables of less than or equal to 90 weight percent (i.e., greater than or equal to 10 weight percent gel content).

““Crosslinkable”, “curable” and like terms means that the polymer, before or after shaped into an article, is not cured or crosslinked and has not been subjected or exposed to treatment that has induced substantial crosslinking although the polymer comprises additive(s) or functionality which will cause or promote substantial crosslinking upon subjection or exposure to such treatment (e.g., exposure to water).

“Rate of crosslinking” is defined as the initial slope of a curve plotting torque versus time in a moving die rheometer test run on molten specimens (generally above 120° C.). Crosslinking kinetics is evaluated using a moving die rheometer (MDR), set at 100 cycles per minute, and an arc of 0.5 degrees. The torque data correlate to the degree of crosslinking as a function of cure time. The minimum torque is a measurement of the viscosity of the uncured compound at molten state. This measurement can show the difference in viscosity between two samples. Maximum torque is a measurement of the shear modulus or stiffness of material after full crosslinking or cure. Generally for polyolefins, the temperature in the MDR chamber is set at temperatures of 140° C. or greater. About six grams of sample are placed on the disk (between Mylar or Teflon films), and the test is started and programmed to stop after certain lengths of time. After the test is stopped, the crosslinked product is removed.

### Ethylene Polymers

The polyethylenes used in the practice of this invention, i.e., the polyethylenes that contain copolymerized silane functionality or are subsequently grafted with a silane, can be produced using conventional polyethylene polymerization technology, e.g., high-pressure, Ziegler-Natta, metallocene or constrained geometry catalysis. In one embodiment, the polyethylene is made using a high pressure process. In another embodiment, the polyethylene is made using a mono- or bis-cyclopentadienyl, indenyl, or fluorenyl transition metal (preferably Group 4) catalysts or constrained geometry catalysts (CGC) in combination with an activator, in a solution, slurry, or gas phase polymerization process. The catalyst is preferably mono-cyclopentadienyl, mono-indenyl or mono-fluorenyl CGC. The solution process is preferred. U.S. Pat. No. 5,064,802, WO93/19104 and WO95/00526 disclose constrained geometry metal complexes and methods for their preparation. Variously substituted indenyl containing metal complexes are taught in WO95/14024 and WO98/49212.

In general, polymerization can be accomplished at conditions well-known in the art for Ziegler-Natta or Kaminsky-Sinn type polymerization reactions, that is, at temperatures from 0-250° C., preferably 30-200° C., and pressures from atmospheric to 10,000 atmospheres (1013 megaPascal (MPa)). Suspension, solution, slurry, gas phase, solid state powder polymerization or other process conditions may be employed if desired. The catalyst can be supported or unsupported, and the composition of the support can vary widely. Silica, alumina or a polymer (especially poly(tetrafluoroethylene) or a polyolefin) are representative supports, and desirably a support is employed when the catalyst is used in a gas phase polymerization process. The support is preferably employed in an amount sufficient to provide a weight ratio of catalyst (based on metal) to support within a range of from 1:100,000 to 1:10, more preferably from 1:50,000 to 1:20, and most preferably from 1:10,000 to 1:30. In most polymerization reactions, the molar ratio of catalyst to polymerizable compounds employed is from 10-12:1 to 10-1:1, more preferably from 10⁻⁹:1 to 10⁻⁵:1.

Inert liquids serve as suitable solvents for polymerization. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes; and aromatic and alkyl-substituted aromatic compounds such as benzene, toluene, xylene, and ethylbenzene.

The ethylene polymers useful in the practice of this invention include ethylene/α-olefin interpolymers having a α-olefin content of between about 15, preferably at least about 20 and even more preferably at least about 25, wt % based on the weight of the interpolymer. These interpolymers typically have an α-olefin content of less than about 50, preferably less than about 45, more preferably less than about 40 and even more preferably less than about 35, wt % based on the weight of the interpolymer. The α-olefin content is measured by ¹³C nuclear magnetic resonance (NMR) spectroscopy using the procedure described in Randall (Rev. Macromol. Chem. Phys., C29 (2&3)). Generally, the greater the α-olefin content of the interpolymer, the lower the density and the more amorphous the interpolymer, and this translates into desirable physical and chemical properties for the protective insulation layer.

The α-olefin is preferably a C₃₋₂₀ linear, branched or cyclic α-olefin. Examples of C₃₋₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins also can contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this invention certain cyclic olefins, such as norbornene and related olefins, particularly 5-ethylidene-2-norbornene, are α-olefins and can be used in place of some or all of the α-olefins described above. Similarly, styrene and its related olefins (for example, α-methylstyrene, etc.) are α-olefins for purposes of this invention. Illustrative ethylene polymers include ethylene/propylene, ethylene/butene, ethylene/1-hexene, ethylene/1-octene, ethylene/styrene, and the like. Illustrative terpolymers include ethylene/propylene/1-octene, ethylene/propylene/butene, ethylene/butene/1-octene, ethylene/propylene/diene monomer (EPDM) and ethylene/butene/styrene. The copolymers can be random or blocky.

The ethylene polymers used in the practice of this invention can be used alone or in combination with one or more other ethylene polymers, e.g., a blend of two or more ethylene polymers that differ from one another by monomer composition and content, catalytic method of preparation, etc. If the ethylene polymer is a blend of two or more ethylene polymers, then the ethylene polymer can be blended by any in-reactor or post-reactor process. The in-reactor blending processes are preferred to the post-reactor blending processes, and the processes using multiple reactors connected in series are the preferred in-reactor blending processes. These reactors can be charged with the same catalyst but operated at different conditions, e.g., different reactant concentrations, temperatures, pressures, etc, or operated at the same conditions but charged with different catalysts.

Examples of ethylene polymers made with high pressure processes include (but are not limited to) low density polyethylene (LDPE), ethylene silane reactor copolymer (such as SiLINK® made by The Dow Chemical Company), ethylene vinyl acetate copolymer (EVA), ethylene ethyl acrylate copolymer (EEA), and ethylene silane acrylate terpolymers.

Examples of ethylene polymers that can be grafted with silane functionality include very low density polyethylene (VLDPE) (e.g., FLEXOMER® ethylene/1-hexene polyethylene made by The Dow Chemical Company), homogeneously branched, linear ethylene/α-olefin copolymers (e.g., TAFMER® by Mitsui Petrochemicals Company Limited and EXACT® by Exxon Chemical Company), homogeneously branched, substantially linear ethylene/α-olefin polymers (e.g., AFFINITY® and ENGAGE® polyethylene available from The Dow Chemical Company), and ethylene block copolymers (e.g., INFUSE® polyethylene available from The Dow Chemical. Company). The more preferred ethylene polymers are the homogeneously branched linear and substantially linear ethylene copolymers. The substantially linear ethylene copolymers are especially preferred, and are more fully described in U.S. Pat. Nos. 5,272,236, 5,278,272 and 5,986,028.

### Silane Functionality

Any silane that will effectively copolymerize with ethylene, or graft to and crosslink an ethylene polymer, can be used in the practice of this invention, and those described by the following formula are exemplary:

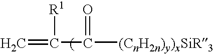

in which R¹ is a hydrogen atom or methyl group; x and y are 0 or 1 with the proviso that when x is 1, y is 1; n is an integer from 1 to 12 inclusive, preferably 1 to 4, and each R″ independently is a hydrolyzable organic group such as an alkoxy group having from 1 to 12 carbon atoms (e.g. methoxy, ethoxy, butoxy), aryloxy group (e.g. phenoxy), araloxy group (e.g. benzyloxy), aliphatic acyloxy group having from 1 to 12 carbon atoms (e.g. formyloxy, acetyloxy, propanoyloxy), amino or substituted amino groups (alkylamino, arylamino), or a lower alkyl group having 1 to 6 carbon atoms inclusive, with the proviso that not more than one of the three R groups is an alkyl. Such silanes may be copolymerized with ethylene in a reactor, such as a high pressure process. Such silanes may also be grafted to a suitable ethylene polymer by the use of a suitable quantity of organic peroxide, either before or during a shaping or molding operation. Additional ingredients such as heat and light stabilizers, pigments, etc., also may be included in the formulation. In any case, the crosslinking reaction typically takes place following the shaping or molding step by moisture-induced reaction between the grafted or copolymerized silane groups, the water permeating into the bulk polymer from the atmosphere or from a water bath or “sauna”. The phase of the process during which the crosslinks are created is commonly referred to as the “cure phase” and the process itself is commonly referred to as “curing”.

Suitable silanes include unsaturated silanes that comprise an ethylenically unsaturated hydrocarbyl group, such as a vinyl, allyl, isopropenyl, butenyl, cyclohexenyl or gamma-(meth)acryloxy allyl group, and a hydrolyzable group, such as, for example, a hydrocarbyloxy, hydrocarbonyloxy, or hydrocarbylamino group. Examples of hydrolyzable groups include methoxy, ethoxy, formyloxy, acetoxy, proprionyloxy, and alkyl or arylamino groups. Preferred silanes are the unsaturated alkoxy silanes which can be grafted onto the polymer or copolymerized in-reactor with other monomers (such as ethylene and acrylates). These silanes and their method of preparation are more fully described in U.S. Pat. No. 5,266,627 to Meverden, et al. Vinyl trimethoxy silane (VTMS), vinyl triethoxy silane, vinyl triacetoxy silane, gamma-(meth)acryloxy propyl trimethoxy silane and mixtures of these silanes are the preferred silane crosslinkers for use in this invention. If filler is present, then preferably the crosslinker includes vinyl trialkoxy silane.

The amount of silane crosslinker used in the practice of this invention can vary widely depending upon the nature of the polymer, the silane, the processing or reactor conditions, the grafting or copolymerization efficiency, the ultimate application, and similar factors, but typically at least 0.5, preferably at least 0.7, weight percent is used. Considerations of convenience and economy are two of the principal limitations on the maximum amount of silane crosslinker used in the practice of this invention, and typically the maximum amount of silane crosslinker does not exceed 5, preferably it does not exceed 3, weight percent.

The silane crosslinker is grafted to the polymer by any conventional method, typically in the presence of a free radical initiator, e.g. peroxides and azo compounds, or by ionizing radiation, etc. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and tert-butyl peracetate. A suitable azo compound is 2,2-azobisisobutyronitrile. The amount of initiator can vary, but it is typically present in an amount of at least 0.04, preferably at least 0.06, parts per hundred resin (phr). Typically, the initiator does not exceed 0.15, preferably it does not exceed about 0.10, phr. The weight ratio of silane crosslinker to initiator also can vary widely, but the typical crosslinker:initiator weight ratio is between 10:1 to 500:1, preferably between 18:1 and 250:1. As used in parts per hundred resin or phr, “resin” means the olefinic polymer.

While any conventional method can be used to graft the silane crosslinker to the polyolefin polymer, one preferred method is blending the two with the initiator in the first stage of a reactor extruder, such as a Buss kneader. The grafting conditions can vary, but the melt temperatures are typically between 160 and 260° C., preferably between 190 and 230° C., depending upon the residence time and the half life of the initiator.

Copolymerization of vinyl trialkoxysilane crosslinkers with ethylene and other monomers may be done in a high-pressure reactor that is used in the manufacture of ethylene homopolymers and copolymers with vinyl acetate and acrylates.

### Catalyst Cure System

Lewis acids are chemical species (molecule or ion) that can accept an electron pair from a Lewis base. Lewis bases are chemical species (molecule or ion) that can donate an electron pair to a Lewis acid. Lewis acids that can be used in the practice of this invention include the tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, stannous octoate, and various other organo-metal compounds such as lead naphthenate, zinc caprylate and cobalt naphthenate. DBTDL is a preferred Lewis acid. Lewis bases that can be used in the practice of this invention include, but are not limited to, the primary, secondary and tertiary amines.

Brønsted acids are chemical species (molecule or ion) that can lose or donate a hydrogen ion (proton) to a Brønsted base. Brønsted bases are chemical species (molecule or ion) that can gain or accept a hydrogen ion from a Brønsted acid. Brønsted acids that can be used in the practice of this invention include sulfonic acid.

The catalyst cure system used in the practice of this invention comprises a Lewis acid paired with a Brønsted acid or a Lewis base paired with a Brønsted base. The molar ratio of Lewis acid to Brønsted acid or Lewis base to Brønsted base is typically between 1:100 and 100:1, preferably between 1:10 and 10:1 and more preferably between 1:2 and 2:1. Preferably, the catalysts cure system comprises more Brønsted acid than Lewis acid.

The minimum amount of catalyst cure system used in the practice of this invention is a catalytic amount. Typically this amount is at least 0.01, preferably at least 0.02 and more preferably at least 0.03, weight percent (wt %) of the combined weight of ethylene-vinylsilane polymer and catalyst cure system. The only limit on the maximum amount of catalyst cure system in the ethylene polymer is that imposed by economics and practicality (e.g., diminishing returns), but typically a general maximum comprises less than 5, preferably less than 3 and more preferably less than 2, wt % of the combined weight of ethylene polymer and catalyst cure system.

### Additives

The composition from which the cable sheathing, e.g., insulation layer, protective jacket, etc., or other article of manufacture, e.g., seal, gasket, shoe sole, etc., is made can be filled or unfilled. If filled, then the amount of filler present should preferably not exceed an amount that would cause unacceptably large degradation of the electrical and/or mechanical properties of the silane-crosslinked, ethylene polymer. Typically, the amount of filler present is between 2 and 80, preferably between 5 and 70, weight percent (wt %) based on the weight of the polymer. Representative fillers include kaolin clay, magnesium hydroxide, silica, calcium carbonate. The filler may or may not have flame retardant properties. In a preferred embodiment of this invention in which a filler is present, the filler is coated with a material that will prevent or retard any tendency that the filler might otherwise have to interfere with the silane cure reaction. Stearic acid is illustrative of such a filler coating. Filler and catalyst are selected to avoid any undesired interactions and reactions, and this selection is well within the skill of the ordinary artisan.

The compositions of this invention can contain other additives such as, for example, antioxidants (e.g., hindered phenols such as, for example, IRGANOX™ 1010 a registered trademark of Ciba Specialty Chemicals), phosphites (e.g., IRGAFOS™ 168 a registered trademark of Ciba Specialty Chemicals), UV stabilizers, cling additives, light stabilizers (such as hindered amines), plasticizers (such as dioctylphthalate or epoxidized soy bean oil), thermal stabilizers, mold release agents, tackifiers (such as hydrocarbon tackifiers), waxes (such as polyethylene waxes), processing aids (such as oils, organic acids such as stearic acid, metal salts of organic acids), colorants or pigments to the extent that they do not interfere with desired physical or mechanical properties of the compositions of the present invention. These additives are used in known amounts and in known ways.

### Compounding/Fabrication

Compounding of the silane-functionalized ethylene polymer, catalyst cure system and additives, if any, can be performed by standard means known to those skilled in the art. Examples of compounding equipment are internal batch mixers, such as a Banbury or Bolling internal mixer. Alternatively, continuous single or twin screw mixers can be used, such as a Farrel continuous mixer, a Werner and Pfleiderer twin screw mixer, or a Buss kneading continuous extruder. The type of mixer utilized, and the operating conditions of the mixer, will affect properties of the composition such as viscosity, volume resistivity, and extruded surface smoothness.

The components of the composition are typically mixed at a temperature and for a length of time sufficient to fully homogenize the mixture but insufficient to cause the material to gel. The catalyst cure system is typically added to ethylene-vinylsilane polymer but it can be added before, with or after the additives, if any. Typically, the components are mixed together in a melt-mixing device. The mixture is then shaped into the final article. The temperature of compounding and article fabrication should be above the melting point of the ethylene-vinylsilane polymer but below about 250° C.

In some embodiments, either or both of the catalyst cure system and the additives are added as a pre-mixed masterbatch. Such masterbatches are commonly formed by dispersing the catalyst cure system and/or additives into an inert plastic resin, e.g., a low density polyethylene. Masterbatches are conveniently formed by melt compounding methods.

### Articles of Manufacture

In one embodiment, the polymer composition of this invention can be applied to a cable as a sheath or insulation layer in known amounts and by known methods (for example, with the equipment and methods described in U.S. Pat. Nos. 5,246,783 and 4,144,202). Typically, the polymer composition is prepared in a reactor-extruder equipped with a cable-coating die and after the components of the composition are formulated, the composition is extruded over the cable as the cable is drawn through the die. Cure may begin in the reactor-extruder.

The formed article is then typically subjected to a cure period, which takes place at temperatures from ambient up to but below the melting point of the polymer until the article has reached the desired degree of crosslinking. In one preferred embodiment, the cure is augmented by externally supplied water permeating into the bulk polymer from the atmosphere or from a water bath or “sauna”. Generally, such a cure may take place at ambient or elevated temperature but the temperature of the cure should be above 0° C.

Other articles of manufacture that can be prepared from the polymer compositions of this invention, particularly under high pressure and/or elevated moisture conditions, include fibers, ribbons, sheets, tapes, tubes, pipes, weather-stripping, seals, gaskets, foams, footwear and bellows. These articles can be manufactured using known equipment and techniques.

The invention is described more fully through the following examples. Unless otherwise noted, all parts and percentages are by weight.

### Specific Embodiments

### Comparative Example 1A

A catalyst masterbatch is made by mixing 97.2 grams (g) of a low density polyethylene (2 g/10 min MI) with 2.6 g of dibutyltin dilaurate (DBTDL) and 0.20 g of LOWINOX® 22IB46 antioxidant (isobutylidene(4,6-dimethylphenol) available from Great Lakes Chemical) in a Brabender mixer at 30 revolutions per minute (rpm) for 5 minutes (min) at 125° C. The masterbatch is taken out and allowed to cool to room temperature after which it is pelletized.

Pelletized masterbatch (5 g) is mixed with 95 g of ethylene-vinyltrimethoxysilane copolymer in a Brabender at 30 rpm for 6 minutes at 125° C. Sample is taken out and allowed to cool to room temperature. Plaques (30 mil thickness) are made from this material in a hot press at 160° C. The plaques are cured at different conditions from which dog-bones are cut and hot-creep tests (ICEA Publication T-28-562-1995) are performed. The crosslinking dynamics are investigated using moving die rheometer (MDR) and the results are reported in the graph of the FIGURE. Samples (4-6 g) are compressed into disks between two sheets of non-interacting film and analyzed by oscillatory rheometry at 100 rpm and 0.5° arc at set temperatures, and the results are reported in the Table.

### Comparative Example 1B

A catalyst masterbatch is made by mixing 97.2 g of the low density polyethylene used in Comparative Example 1A with 2.6 g sulfonic acid B201 available from King Industries and 0.20 g of LOWINOX® 22IB46 antioxidant in a Brabender at 30 rpm for 5 min at 125° C. The masterbatch is taken out and allowed to cool to room temperature after which it is pelletized. Plaques are prepared and tested using the same materials and techniques as those in Comparative Example 1A, and the results are reported in both the FIGURE and the Table.

### Example 1

A catalyst masterbatch is made by mixing 97.2 g of the low density polyethylene used in the Comparative Examples with 1.3 g DBTDL, 1.3 g sulfonic acid (B201) and 0.20 g LOWINOX® 22IB46 in a Brabender at 30 rpm for 5 min at 125° C. The masterbatch is taken out and allowed to cool to room temperature after which it is pelletized. Plaques are prepared and tested using the same materials and techniques as those in Comparative Example 1A, and the results are reported in both the FIGURE and the Table.

TABLE
Percent Elongation of 30 mil Plaques Cured at 23° C.
and 70% Relative Humidity
and Tested at 150° C. at 0.2 MPa for 15 Minutes

| | Sulfonic | | | | | 23° C. | |
|---|---|---|---|---|---|---|---|
| | Acid g/ | DBTDL | 90° C. water bath | | | 70% RH | |
| Example | 100 g | g/100 g | 0 hr | 1 hr | 3 hr | 16 hr | 24 hr |
| Comp. Ex. 1A | — | 0.13 | fail | 104 | 54 | fail | fail |
| Comp. Ex. 1B | 0.13 | — | fail | 45 | 33 | 125 | 83 |
| Ex. 1 | 0.06 | 0.06 | fail | 30 | 25 | 143 | 76 |

*R.H. means relative humidity

### Discussion

The rate of crosslinking in the MDR experiment, at a test temperature of 200° C., is very slow with either DBTDL alone or sulfonic acid alone as cure catalyst. Surprisingly, using the combination of DBTDL and sulfonic acid resulted in rapid crosslinking in the MDR experiment at the same test conditions.

The plaques made with combination formulation are tested against the individual components for cure studies at room temperature (23° C., 70% RH) and at 90° C. in a water bath. The hot creep data of cured plaques are summarized in the Table. Before curing (0 hrs) all samples fail the hot-creep test indicating no crosslinking occurred. This confirms that none of the samples is cured prior to aging. The sample with 0.13 wt % DBTDL had a percent elongation of 104 after 1 hour of cure in the water bath at 90° C. When aged under identical conditions with the same amount of the catalyst cure system of this invention, however, a percent elongation of 45 is obtained. The combination of 0.06 wt % of DBTDL and 0.06 wt % of sulfonic acid results in a percent elongation of 30 under the same conditions. Under ambient conditions, the formulation with DBTDL was unable to cure the silane copolymer even after 24 hours. Using 0.13 wt % sulfonic acid as catalyst cured the silane copolymer within 16 hours. The catalyst cure system with 0.06 wt % of each cure catalyst showed similar cure performance under ambient conditions. Using DBTDL as the catalyst lowers the energy of the transition state of the condensation step for silanols and the rate controlling step is the hydrolysis of alkoxysilanes. For the case of sulfonic acid catalysis, the rate controlling step is the condensation step. On using a mixture of the two cure catalysts, both transition states are stabilized to a greater degree. Thus using the catalyst cure system of this invention, each catalyst with a different rate controlling regime, helps in hastening the rate of cure.

Although the invention has been described with certain detail through the preceding specific embodiments, this detail is for the primary purpose of illustration. Many variations and modifications can be made by one skilled in the art without departing from the spirit and scope of the invention as described in the following claims.

What is claimed is:

1. A process for crosslinking an ethylene-vinyl silane polymer, the process comprising the step of contacting the ethylene-vinylsilane polymer and water with a catalyst cure system comprising a combination of at least one Lewis acid and at least one Brønsted acid or at least one Lewis base and at least one Brønsted base.

2. The process of claim 1 in which the catalyst cure system comprises a Lewis acid and a Brønsted acid.

3. The process of claim 2 in which the Lewis acid and Brønsted acid are present in a molar ratio between 1:2 and 2:1.

4. The process of claim 3 in which the catalyst cure system is present in an amount between 0.01 and 5 weight percent based on the combined weight of the polymer and the catalyst cure system.

5. The process of claim 4 in which the polymer is cured under ambient conditions.

6. The process of claim 5 in which the polymer is a copolymer of ethylene polymerized with a vinyl trialkoxy silane comonomer.

7. The process of claim 5 in which the polymer is a silane-grafted ethylene polymer.

8. The process of claim 5 in which the Lewis acid is dibutyltin dilaurate and the Brønsted acid is sulfonic acid.

9. A crosslinkable composition comprising an ethylene-vinyl silane polymer and a catalyst cure system comprising a combination of at least one Lewis acid and at least one Brønsted acid or at least one Lewis base and at least one Brønsted base.

10. The composition of claim 9 in which the catalyst cure system comprises a Lewis acid and a Brønsted acid.

11. The composition of claim 10 in which the Lewis acid and Brønsted acid are present in a molar ratio between 1:2 and 2:1.

12. The composition of claim 11 in which the catalyst cure system is present in an amount between 0.01 and 5 weight percent based on the combined weight of the polymer and the catalyst cure system.

13. The composition of claim 12 in which the polymer is a copolymer of ethylene polymerized with a vinyl trialkoxy silane comonomer.

14. The composition of claim 12 in which the polymer is a silane-grafted ethylene polymer.

15. The composition of claim 12 further comprising an additive.

16. The composition of claim 15 in which the additive is at least one of an antioxidant, UV stabilizer, cling additive, light stabilizer, plasticizer, thermal stabilizer, mold release agent, tackifier, wax, processing aid, filler, colorant and pigment.

17. The composition of claim 16 in which the Lewis acid is dibutyltin dilaurate and the Brønsted acid is sulfonic acid.

18. An article made from the composition of claim 9.

19. The article of claim 18 in the form of a cable sheath, foam or insulation.

20. A process for crosslinking an ethylene-vinyl silane polymer, the process comprising the step of contacting the ethylene-vinylsilane polymer and water with a catalyst cure system comprising at least one Lewis acid and at least one Brønsted acid or of at least one Lewis base and at least one Brønsted base such that the rate of cure of the ethylene-vinylsilane polymer is greater than 10 percent faster than the rate of cure of the same ethylene-vinylsilane polymer under the same conditions but with either of the Lewis acid or base or Brønsted acid or base alone.
